(19) United States
(12) Patent Application Publication
(10) Pub. No.: US 2022/0142138 A1
(43) Pub. Date: May 12, 2022

(54) Device for Humanely Catching and Releasing Flying and Crawling Insects

(71) Applicants: Susan E. Bies, Waconia, MN (US); A. Maynard Engebretson, Chesterfield, MO (US)

(72) Inventors: Susan E. Bies, Waconia, MN (US); A. Maynard Engebretson, Chesterfield, MO (US)

(21) Appl. No.: 17/096,505

(22) Filed: Nov. 12, 2020

(51) Int. Cl. A01M 1/10

(52) U.S. Cl. CPC A01M 1/103; A01M 2200/012; A01M 2200/011; A01M 1/106

(57) ABSTRACT

This device for humanely catching and releasing flying and crawling insects is a lightweight, handheld tool to capture an insect on a flat surface inside the home without getting too close to it and releasing it outside unharmed. The container is clear and transparent to easily confirm that the insect is inside. Once the insect is captured, turning the control knob on the handle rotates the cover to secure the container. There are three small spacers on the bottom of the container, which allow the cover to be closed and latched without having to move the container and without injuring the insect. The self-aligning latch mechanism ensures that once closed, the cover will not open inadvertently while transporting the captive insect. Once the insect has been carried outside, the control knob on the end of the handle is turned to open the cover and release the insect unharmed.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

It is common to have an insect get inside your house and become trapped. Often it ends up on a window, or the floor, wall, or ceiling. Once an insect is inside, it can be challenging to safely catch and release it. A glass with a piece of paper slid underneath it is the traditional way to catch and release an insect in a way that does not harm it. But for those of us who are mildly afraid of insects, that is a challenging and stressful approach. If the paper is not held securely against the glass while moving it, the approach can easily result in the insect escaping the glass while still in the house, so that it all must be done again. This device for humanely catching and releasing flying and crawling insects is simple to use and more effective. The long handle allows you to stand further away from the insect, which makes capture easier and it feels safer. The rotating cover and latch allow you to easily secure the insect inside the container so that it cannot escape. Many of the other bug capturing devices available today work in a way that kills the insect, but this unique device allows you to easily catch the insect and release it outside unharmed.

### BRIEF SUMMARY OF THE INVENTION

This device for humanely catching and releasing flying and crawling insects is a lightweight, handheld tool that can be used to capture an insect on a flat surface inside the home and release it outside unharmed. The device has a long handle so that the insect can be captured on a flat surface while standing at a distance. The insect is captured by reaching the device out to the flat surface and covering the insect with the clear, transparent container pressed against the flat surface. The container is clear and transparent so that it is easy to confirm that the insect is in the container. Once the insect is in the container, the control knob on the end of the handle is used to close the cover of the container. There are three small spacers on the bottom of the container, which allow the cover to be closed and latched without having to move the container and without injuring the insect. The self-aligning latch mechanism ensures that once closed, the cover will not open inadvertently while the captive insect is being transported. Once the insect is carried outside, the control knob on the end of the handle is used to open the cover and release it unharmed.

This device allows an insect to be safely captured from a distance and to be released outside unharmed. For a more complete understanding of the invention, please refer to the following specification and to the accompanying drawings.

### BRIEF DESCRIPTION OF THE DRAWINGS

FIG. 1 is a plan view of the invention showing the container 101 and cover 102 and the operating knob 103 that is connected to the cover via a shaft 106 and flange 107 as a means of opening and closing the cover by rotation.

FIG. 2A illustrates the fixed receptacle part of the self-aligning latch which is a tapered opening cut into the rim of the container that engages the moving latch hook 109 which holds the cover against the rim of the container when closed and prevents it from accidental opening. The shape of the latch opening is designed to accommodate a slightly misaligned hook and to guide the hook up and over a slight bump to a final resting position when closed.

FIG. 2B illustrates the fixed and moving parts of the latch together in a closed position. The hook is made of a springy material and attached to the edge of the cover.

### DETAILED DESCRIPTION OF THE INVENTION

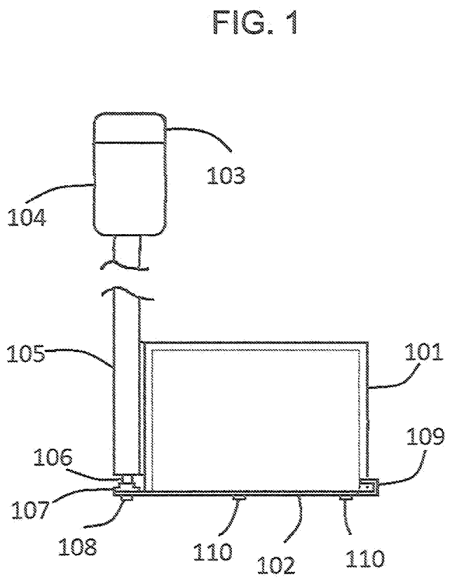

One embodiment of this invention is illustrated in FIG. 1. It is comprised of a container 101, a cover 102, a handle 105, a grip 104 and control knob 103. When in use, the invention is held by the handle, the open container is placed over the insect, the cover is closed, and the entrapped insect is taken outdoors and the cover is opened to release the insect safely. The container, which is about 8 cm in diameter by 8 cm deep, is made of a clear, transparent material that makes it possible to view the entrapped insect inside.

The cover is made of a thin, rigid material. It rotates—to open and close the container—around a pivot point slightly outside the radius of the container rim. Opposite this pivot point, as part of the cover, is a latch hook 109 that secures the cover to the rim of the container when closed.

The cover is opened and dosed by rotating the control knob 103. The control knob is connected to the cover by way of a shaft 106 and flange 107. The flange distributes the torque pressure applied by the shaft to the cover to provide a strong connection. The shaft is securely attached to the control knob. The shaft is supported by the handle 105 which has an inside diameter slightly larger than the outside diameter of the shaft. This allows the shaft to rotate freely within the handle. The handle is securely attached to the container. The handle is about 35 cm long which provides for a safe distance from the insect while operating the device.

When the rim of the container is held against a window or other flat surface with the insect trapped within, it is necessary to provide clearance for the cover to be rotated to a closed position. However, if the clearance is too large, the insect may escape. The clearance is provided for in this invention by three small spacers located around one-half of the circumference of the container rim. These spacers provide a small clearance—a few mm—between the cover, the container rim and the window or other flat surface. One of the spacers 108 is an extension of the shaft through the flange and cover. The other two spacers 110 are attached to the outside surface of the container at about 85 and 170 degrees around the rim from the shaft. This provides a stable three-point base of support for operating the device. An equally effective means of holding the device away from the surface to provide clearance for the cover is to use a continuous thin skirt, instead of individual spacers, attached to the rim.

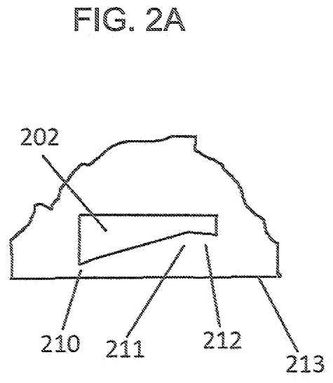

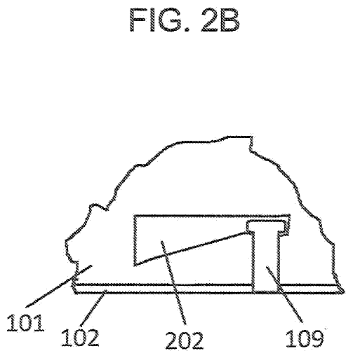

FIG. 2A illustrates the design of the latching receptacle 202 which is located on and near the rim of the container 213 opposite the location of the pivot point of the cover. As the cover is closed, the latch hook encounters the open end of the receptacle 210 which is widened to accommodate slight misalignment of the cover and latch hook. As the cover closes, the latch hook is guided up the incline and over the bump 211 into a latch closed position 212. The latch hook is made of a springy material that when extended creates a spring force as the hook moves up the incline of the latch receptacle. This spring force holds the cover securely against the container rim. This force also holds the cover closed because to open the cover from the closed position the latch hook must be extended against this spring force to slide over the bump in the receptacle.

FIG. 2B shows the latch hook in the latch closed position.

What is claimed is:

1. A method of capturing flying and crawling insects indoors and releasing them outdoors unharmed with a device consisting of a transparent container, cover and handle and means for opening and closing the cover by rotation.

2. A method of opening and closing the rotating cover of claim 1 with a control knob located at a safe distance from the open end of the container.

3. A method of latching the cover of claim 1 that is self-aligning and that holds the cover firmly against the rim of the container when closed and resists the cover from opening accidently when closed.

4. A method of spacing the container of claim 1 away from the underlying wall or window surface that provides clearance for the cover to move between the container rim and underlying surface.
